(19) United States
(12) Patent Application Publication
(10) Pub. No.: US 2006/0041528 A1
(43) Pub. Date: Feb. 23, 2006

(54) Method and planning tool operable to retrieve additional information from an external source

(75) Inventors: Stefan List, Fuerth (DE); Josef Poertner-Von Der Marwitz, Nuernberg (DE)

Correspondence Address: SUGHRUE MION, PLLC, 2100 PENNSYLVANIA AVENUE, N.W., SUITE 800, WASHINGTON, DC, 20037, US

(73) Assignee: SIEMENS AKTIENGESELLSCHAFT

(21) Appl. No.: 11/046,729

(22) Filed: Feb. 1, 2005

Related U.S. Application Data
(63) Continuation of application No. PCT/DE03/02593, filed on Aug. 1, 2003.

(30) Foreign Application Priority Data
Aug. 1, 2002 (DE) 102 35 215.1

(51) Int. Cl. G06F 17/30

(52) U.S. Cl. 707/2

(57) ABSTRACT

A method for planning an automation process and a planning tool (10) run on a computer (14) for the selection of automation components represented by data records (20), such as automation components suitable for the control and/or monitoring of a technical process for automation. The automation components (20) are selected using display screen-supported selection dialogs of the planning tool (10). Additional information is automatically retrieved for a selected automation component (20), such as technical documentation, driver updates, pricing or ordering information, from a data pool (26) located on a source (22) external to the computer (14).

This is a Continuation of International Application PCT/DE2003/002593, with an international filing date of Aug. 1, 2003, which was published under PCT Article 21(2) in German, and the disclosure of which is incorporated into this application by reference.

### FIELD AND BACKGROUND OF THE INVENTION

1. Field of the Invention

The present invention relates to a computerized method and a software-implemented planning tool. In particular, the present invention relates to a method and a planning tool for selection of automation components by displaying screen-supported selection dialogs and/or for the configuration and parameterization of the automation components.

2. Description of Related Art

The generic term automation component as used hereinafter denotes any type of hardware adapted to control and/or monitor a technical process, e.g., intelligent control equipment such as process control computers, programmable controllers or decentralized peripherals, etc., and input and/or output modules for such computers, controllers or peripherals configured to connect to digital or analog inputs or outputs of the technical process. Automation components further include connections for communication between the above devices. For example, these connections can be bus interfaces, bus connections and the like. The automation components also include functional units such as controllers and motor controls, e.g., frequency converters, speed monitors, limit monitors and etc. Finally, the automation components also include the respective software functionalities required to operate the individual units.

The automation components are provided to monitor and/or influence the so-called process peripherals, i.e., devices such as switches, pushbutton controls, limit switches (mechanical, inductive or capacitive), photoelectric barriers and the like. These process peripherals are used to detect states of the controlled and/or monitored technical process, and equipment such as valves, motors, lighting means, and the like. The process peripherals are used to influence the technical process.

The devices of the automation components described above are given by way of an example only and other functionally equivalent devices or equipment known in the field of the automation of technical processes, are collectively referred to as automation components. Individual devices from this spectrum, e.g., a programmable controller or a decentralized peripheral device, are hereinafter also referred to as automation devices.

A generic planning tool, e.g., with the “hardware configuration (HW Config)” functionality, is known from the development environment offered by Siemens AG under the name “Step 7.” This development environment is provided for use with a type series of Siemens automation devices known under the name “SIMATIC S7.”

The known planning tool already extensively supports the user in the selection of individual automation components. In this known planning tool, however, if the user requires additional information on specific automation components, he or she resorts to a manual, for example. Alternatively or in addition, the user contacts a technical customer support service by telephone. If the user decides to resort to the manual, the user first has to find this manual among the many technical documents at his or her disposal. Once the manual is found, the question arises whether it is complete and up to date. If the user needs to resort to the technical customer support service, the user first has to find the telephone number. Once the telephone number is found and a connection with the technical customer service is established, the user often has to explain the problem to several specialists in succession, before he finds the one who is best qualified to provide support in finding a solution.

### OBJECTS OF THE INVENTION

Thus, one object of the present invention is to provide a planning tool, which supports the user not only in the selection of the individual automation component but also provides access to additional information for the selected automation components.

Illustrative, non-limiting embodiments of the present invention may overcome the above disadvantages and other disadvantages not described above. The present invention is not necessarily required to overcome any of the disadvantages described above, and the illustrative, non-limiting embodiments of the present invention may not overcome any of the problems described above. The appended claims should be consulted to ascertain the true scope of the invention.

### SUMMARY OF THE INVENTION

According to an illustrative, non-limiting formulation of the present invention, a planning tool for running on a computer and for the selection and, in particular, the configuration and parameterization of automation components of the above-described type is provided. The planning tool has a display screen-supported selection dialog, which makes it possible to automatically retrieve additional information external to the computer for a selected automation component.

According to another illustrative, non-limiting formulation of the present invention, a computerized method for planning an automated technical process is provided. In this method, a user selects automation components for the automated technical process via selection dialogs displayed on a computer of the user. Then the user may request additional information for one or more of the selected automation components. The request, along with a unique identifier for each of the selected automation components, is automatically transmitted to a remote source. The remote source automatically locates the additional information related to the selected automation component according to the unique identifier and transmitted this additional information to the user computer. The transmitted information is presented to the user.

The exemplary formulation of the present invention is based on the recognition that due to continuous product innovation, aided by software that can be adapted at any time, the available information on individual automation components is permanently changing. Information delivered together with an automation component to the person who ordered it, e.g., in the form of a manual or some other technical documentation, reflects only the state of knowledge at the time when the information is delivered, more specifically, the state of knowledge at the time of preparing the manual.

Any information added or modified after the delivery or preparation of the manual is available to the individual who ordered the automation component only if he or she actively searches for it on the Internet, for example, or if this individual contacts the technical customer service or a similar service by telephone. This type of access to information is no longer appropriate today. The planning tool according to the exemplary formulation of the present invention therefore includes a functionality to automatically retrieve additional information external to the computer on which the planning tool is running. The additional information can be retrieved, for example, from a database operated by the supplier of the selected automation component.

Thus, preferably, according to the exemplary formulation, the user of the planning tool has access to the latest additional information about each selected automation component at any time. Access is particularly user friendly if the additional information can be retrieved individually for each selected automation component. A type designation or order number of the selected automation component can then be used for selective access to the respective remote database. In response, the information offered or returned to the user relates only to the selected automation component, such that the user receives precisely the information that is relevant for him or her. If the user selects a group of automation components for which additional information is to be retrieved, the additional information available for each selected automation component or only the additional information relating to all of the selected automation components is retrieved.

For example, whether to provide additional information related to only one or all of the selected automation components may depend on the user selection of the additional information or may be provided as an option in the screen -supported selection dialogues.

Some of the exemplary refinements of the formulation are described below.

For example, additional information can be retrieved by accessing the Internet.

When the additional information can be retrieved through the Internet, the information can be accessed more easily. Internet access is widely available today and attractive data transfer rates can be used. Moreover, Internet access can also be used to get other information, i.e., all the information that is available on the Internet. No special hardware or software, apart from the hardware and software needed to access the Internet, is necessary to use the expanded functionality of the planning tool.

Another refinement of the formulation is including documentation on the selected automation components as additional information for these selected automation components. If the additional information includes documentation on the selected automation component, the user can get up to date documentation. This eliminates the concern that certain capabilities of the selected automation components would not be used to the optimal extent.

Yet another refinement of the exemplary formulation includes providing expert information regarding the selected automation component. If the additional information includes information of experts, e.g., access to a technical customer service, to customer support, a hotline, FAQs (Frequently Asked Questions), etc., up-to-date information not yet included in the technical documentation and/or solutions proposed either by the supplier or by other users of the automation component not yet included in the technical documentation, etc., can be retrieved.

Another refinement of the exemplary formulation includes delivery information for the selected automation component. If the additional information includes delivery information for the selected automation component, the user can ensure at an early stage that the automation project is planned or continued only with automation components that are actually available in sufficient quantities.

Furthermore, the additional information according to the exemplary formulation may include ordering information. If the additional information includes ordering information for the selected automation components, the ordering information can be used to generate a purchase order for the selected automation component, eliminating the risk that mistakes be introduced, e.g., during the specification of the selected automation component.

Moreover, the additional information according the exemplary formulation may include offers for training on how to use the selected automation component. If the additional information includes training offers for the selected automation component, a user who has never used the selected automation component, for example, and who would like to do so in the future can get information on the training available and take advantage of these offers, so that he can ultimately make use of the selected automation component to the optimal extent.

Preferably, the planning tool according to the exemplary formulation includes a functionality to generate the purchase orders. If the planning tool includes the functionality to generate the purchase order for each automation component selected, some or all of the required automation components can be ordered directly from the planning tool, without the risk of communication errors, such as transposed digits, which could occur if the order information has to be copied multiple times. Using the planning tool to place the order for all of the automation components also ensures that no automation components is forgotten, so that all the necessary automation components will actually be available at the time when they are needed.

Preferably, such an order is placed through the website of the respective supplier of each automation component selected.

### BRIEF DESCRIPTION OF THE DRAWINGS

The present invention will now be described in detail by describing illustrative, non-limiting embodiments thereof with reference to the accompanying drawings. In the drawings, the same reference characters denote analogous elements:

FIG. 1 shows a planning tool during access to a data pool on an external computer according to an exemplary, non-limiting embodiment of the present invention, and

FIG. 2 illustrates a lookup table according to another exemplary embodiment of the present invention, which is provided on the external computer for rapid access to the data pool.

### DETAILED DESCRIPTION OF ILLUSTRATIVE, NON-LIMITING EMBODIMENTS

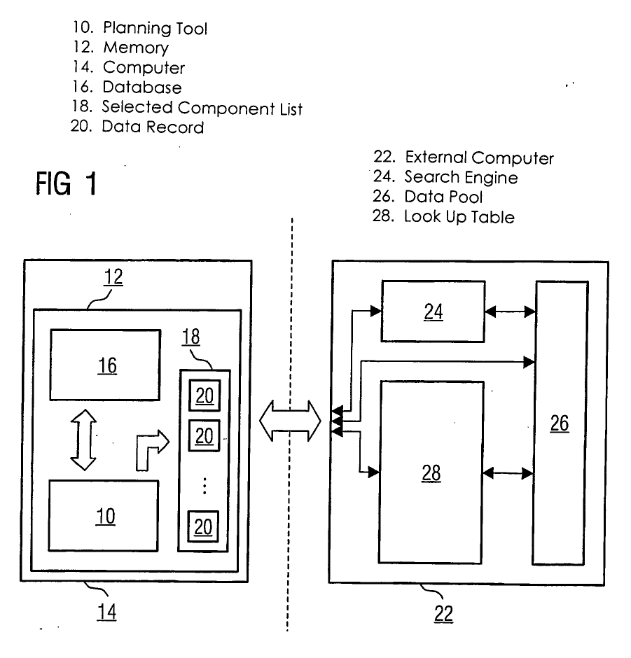

FIG. 1 shows a software-implemented planning tool 10, which is stored in a memory 12 of a computer 14 and runs on the computer 14 in a known manner. To select, or when selecting individual automation components, the planning tool 10 accesses a database 16, which is likewise stored in the memory 12 of the computer 14. For each automation component, the planning tool 10 retrieves from the database 16 at least the data required to enable the user to decide whether a given automation component is suitable for the planned application.

Such data include information on the type and functionality of each automation component. For example, these data for a central processing unit of a programmable controller includes information on the processing speed, the memory space, the number of addressable inputs and outputs, and etc. In addition, however, the data for each automation component also include a unique identifier, e.g., in the form of a type designation and/or an order number.

All of the automation components selected are stored in a component list 18. This component list 18 has a number of data records 20. Each data record 20 represents a selected automation component. Each data record includes at least the aforementioned unique identifier. At any time, this identifier can be used to access the database 16, in order to retrieve additional data for the respective automation component. The unique identifier thus approximately corresponds to a “code,” that is used in a database, for example, for direct access to a specific data record.

If certain information cannot be retrieved from the database 16, e.g., because this information cannot be stored in the database 16—due to insufficient memory, for example—or because the information contained in the database is out of date, the desired information is automatically requested as additional information from an external computer 22 outside of the computer 14. The block arrow between the computer 14 and the external computer 22 represents a communication link between the two computers 14, 22, e.g., an Internet connection.

To retrieve the additional information, at least the unique identifier of the respective automation component is transmitted to the external computer 22. For example, an external computer 22 may be a remote computer. On the side of the external computer 22, the unique identifier is processed like a search string by a search engine 24. The external computer 22 then returns, as a result of this search, all the occurrences of the unique identifier in a data pool 26. Each occurrence of the unique identifier in the data pool 26 can then be transmitted to the planning tool 10.

Optionally, each occurrence of the unique identifier found in the data pool 26 can be supplemented by additional explanations, e.g., regarding the type and contents of the data found. Accordingly, by using the additional explanations, the user of the planning tool 10 can select the information he or she wants to use from the additional information being offered. As in the Internet, the data that is transmitted to the planning tool 10 already include a unique reference to the memory address of the additional information in the data pool 26. As a result, when the user of the planning tool 10 selects specific additional information, the system directly accesses the data pool 26 to fetch the additional information.

To select certain additional information, e.g., current pricing information, each item of information in the data pool 26 can be assigned to at least one category. In other words, if additional information on the automation component is retrieved, e.g., in the form of pricing information, not only the unique identifier characterizing the respective automation component but also an identifier characterizing the respective category is transmitted to the external computer, i.e., to the search engine 24, for example. The search engine 24 then returns only those occurrences of the unique identifier in the data pool 26 which are assigned to the desired category, such that the user of the planning tool 10 finally receives precisely the additional information desired, e.g., the desired pricing information.

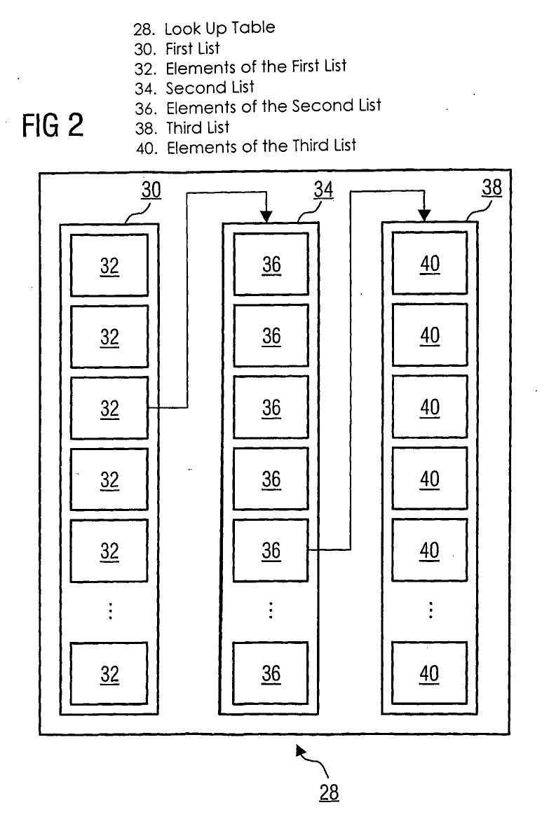

In addition or as an alternative to the search engine 24, a lookup table 28 may be provided. A lookup table 28 according to an exemplary, non-limiting embodiment of the present invention is depicted in FIG. 2. The search engine 24, data pool 26, and lookup table 28 are provided on the external computer 22 in a memory (not depicted) in a manner known to one of ordinary skill in the art. Particularly, the data pool 26 can be provided as a distributed data pool 26 in the memory of a number of interconnected external computers 22.

FIG. 2 shows the lookup table 28 with a first list 30. The first list 30 includes a number of list elements 32. Each list element 32 of the first list 30 is associated with a second list 34, which in turn has a number of list elements 36. In the example depicted in FIG. 2, only one second list 34 out of a number of second lists 34 is depicted. Each list element 36 of the second list 34 is associated with a third list 38, which in turn includes a number of list elements 40. Again, in the example depicted in FIG. 2, only one third list 38 out of a number of third lists 38 is shown.

When a unique identifier of an automation component is transmitted, for which additional information is to be retrieved using the lookup table 28, the unique identifier is compared with a respective content of the list elements 32 in the first list 30. When a match is found, the system goes to the second list 34 associated with the respective list element 32 of the first list 30. This second list 34 includes a separate list element 36 for each category of the additional information, i.e., for example, pricing information, availability information, technical information, etc. If data regarding the category from which the additional information is to be retrieved were previously transmitted together with the unique identifier, these data can be compared with the respective content of the list element 36 of the second list 34. When a match for the category is found, the system goes to the third list 38 associated with the respective list element 36 of the second list 34. The list elements 40 of the third list 38 contain addresses under which additional information of the respective category for the selected automation component can be retrieved from the data pool 26 (FIG. 1). The addresses, optionally supplemented by additional textual explanations, are transmitted to the planning tool 10 (FIG. 1), such that the user can select the appropriate additional information from a number of additional information provided.

If no data on a category, from which the desired additional information is to originate, are transmitted together with the unique identifier that characterizes the selected automation component, the addresses of all the additional information on the selected automation component are transmitted to the planning tool 10 (FIG. 1). The planning tool preferably displays the available additional information in a structured manner, such that additional information of a category, even combined, is presented to the user, e.g., on a display screen. The user can then make a preliminary selection using the categories in which additional information is available and then retrieve the individual items of additional information.

The search engine 24 (FIG. 1) can also access the lookup table 28, either to accelerate the search or to consider the additional information that the lookup table 28 may contain.

To generate the purchase order, the component list 18, or selected parts thereof are transmitted to the external computer 22 together with information that encodes the generating of the purchase order. On the side of the external computer 22, either the transmitted data of the component list 18 alone or these data, supplemented by order information from the data pool 26, which is likewise determined within the external computer 22 according to the above-described method, either using the search engine 24 and/or the lookup table 28, are used to order the respective automation component.

Optionally, these data are forwarded to an additional computer (not depicted), which is provided specifically for the processing of orders.

According to the exemplary, non-limiting embodiment of the present invention, a planning tool 10 to be run on a computer 14 is provided for the selection of automation components, such as the components suitable for the control and/or monitoring of a technical process to be automated, using screen-supported selection dialogs. Additional information can be automatically retrieved for a selected automation component, e.g., technical documentation, driver updates, pricing and ordering information, etc., from a source external to the computer 14.

The above description of illustrative, non-limiting embodiments and variations thereof has been given by way of an example. The above and other features of the invention including various novel method steps and various novel components have been particularly described with reference to the accompanying drawings and pointed out in the claims. It will be understood that the particular process and construction of parts embodying the invention is shown by way of an illustration only and not as a limitation of the invention. The principles and features of this invention may be employed in varied and numerous embodiments without departing from the scope of the invention as defined by the appended claims and equivalents thereof.

What is claimed is:

1. A planning tool run on a computer, comprising:
screen-supported selection dialogs providing a user with an ability to select automation components,
wherein a source external to the computer stores additional information, and the planning tool is configured to automatically retrieve the additional information for a selected automation component.

2. The planning tool as claimed in claim 1, wherein the additional information is retrieved by accessing Internet.

3. The planning tool as claimed in claim 2, wherein the additional information comprises documentation on the selected automation component.

4. The planning tool as claimed in claim 2, wherein the additional information comprises expert information on the selected automation component.

5. The planning tool as claimed in claim 2, wherein the additional information comprises information relating to delivery of the selected automation component.

6. The planning tool as claimed in claim 2, wherein the additional information comprises ordering information for the selected automation component.

7. The planning tool as claimed in claim 2, wherein the additional information comprises information on training offers relating to the selected automation component.

8. The planning tool according to claim 7, wherein the training offers comprise offers for training for operating the selected automation component.

9. The planning tool as claimed in claim 2, further comprising a module to generate a purchase order for the selected automation component.

10. The planning tool as claimed in claim 9, wherein the order is placed through a website of a respective supplier of the selected automation component.

11. The planning tool as claimed in claim 1, wherein the additional information comprises documentation on the selected automation component.

12. The planning tool as claimed in claim 1, wherein the additional information comprises expert information on the selected automation component.

13. The planning tool as claimed in claim 1, wherein the additional information comprises information relating to delivery of the selected automation component.

14. The planning tool as claimed in claim 1, wherein the additional information comprises ordering information for the selected automation component.

15. The planning tool as claimed in claim 1, wherein the additional information comprises information on training offers relating to the selected automation component.

16. The planning tool as claimed in claim 1, further comprising a functionality to generate a purchase order for the selected automation component.

17. The planning tool as claimed in claim 16, wherein the order is placed through a website of a respective supplier of the selected automation component.

18. A computerized method for planning an automated technical process, the method comprising:
selecting by a user automation components for the technical process via selection dialogs displayed on a computer of the user;
requesting by the user additional information for at least one of the selected automation components;
automatically transmitting to a remote source the request along with a unique identifier for the at least one selected automation component;
automatically locating the additional information relating to the at least one selected automation component according to the unique identifier;
transmitting to the user computer the located additional information; and
providing the user with the transmitted additional information.

19. The method according to claim 18, wherein the user request for the additional information further comprises a type of information desired, and wherein the remote source locates the additional information relating to the at least one selected automation components according to the unique identifier and the type of information desired.

20. The method according to claim 18, wherein when at least two automation components are selected by the user, the user selects whether to request the additional information related to each individual selected component or the additional information that relates to all of the selected components.

21. The method according to claim 18, wherein the additional information comprises at least one of: documentation, expert knowledge, delivery information, ordering information, offers for training, and wherein the user computer communicates with the remote source via internet.
